(19) United States
(12) Patent Application Publication
(10) Pub. No.: US 2009/0307732 A1
(43) Pub. Date: Dec. 10, 2009

(54) Personalized Insertion of Advertisements in Streaming Media

(76) Inventors: Noam Cohen, Binyamina (IL); Gennady Rafalovich, Gan-ner (IL)

Correspondence Address: Martin P Hoffman;Hoffman Wasson & Gitler, 2461 South Clark Street, Suite 522, Arlington, VA, 22202, US

(21) Appl. No.: 12/224,829

(22) PCT Filed: Mar. 6, 2007
(86) PCT No.: PCT/IL2007/000282

§ 371 Date: Nov. 25, 2008

Related U.S. Application Data
(60) Provisional application No. 60/780,095, filed on Mar. 7, 2006.

(51) Int. Cl. H04N 7/173

(52) U.S. Cl. 725/87

(57) ABSTRACT

Apparatus (20) for digital media distribution includes a plurality of client devices (26) coupled to a network (24). Each client device is configured to receive and play a primary digital broadcast media stream from a first server (22) and to receive, via the network, an indication of an interval in the primary digital broadcast media stream in which secondary content is to be played on the output device. A control subsystem (36) transmits to the client devices, via the network, a message identifying at least one second server (34) that is to provide the secondary content. The message causes the client devices to suspend reception of the primary digital broadcast media stream at the start time while connecting to receive the secondary content from the at least one second server so as to play the secondary content during the interval.

### CROSS-REFERENCE TO RELATED APPLICATION

This application claims the benefit of U.S. Provisional Patent Application 60/780,095, filed Mar. 7, 2006, whose disclosure is incorporated herein by reference.

### FIELD OF THE INVENTION

The present invention relates generally to multimedia broadcasting over digital networks, and specifically to methods and systems for interleaving individualized content into a broadcast media stream.

### BACKGROUND OF THE INVENTION

Packet broadcast of multimedia streams is gaining popularity as a method for distribution of audio and video content over networks of various types. For example, multicast capabilities of Internet Protocol (IP) networks may be used in real-time distribution of packetized audio and video streams over the Internet to selected clients. Other examples of digital broadcast include distribution of real-time packetized media content over cable entertainment and direct-broadcast satellite (DBS) networks. In the context of the present patent application and in the claims, the term “broadcast” refers generally to any and all types of point-to-multipoint real-time content distribution over a network (of which IP multicast is one example).

Video network service providers derive a substantial part of their revenues from advertisements that are inserted into the video program. Various methods are known in the art for inserting such advertisements into the video stream. For example, U.S. Pat. No. 6,771,644 describes a method for “seamless” insertion of a secondary program within an IP multicast session of a primary program. A primary content provider transmits its multimedia stream to a first proxy, which transmits the data to a destination multicast session. A secondary content provider sends a request through a second proxy to the first proxy requesting a time slot to insert secondary program. At the appropriate time, the first proxy transfers control of the destination multicast session to the second proxy, which transmits the secondary program. Upon completion of the secondary program the second proxy returns control of the session to the first proxy.

### SUMMARY OF THE INVENTION

Embodiments of the present invention provide methods and systems for insertion of differentiated secondary content into certain time slots in a digital media broadcast stream. The secondary content is “differentiated” in the sense that different clients of the broadcast stream may receive different secondary content for the same time slot, depending on specific characteristics of the individual clients. In one embodiment, which is described in detail hereinbelow, the secondary content comprises advertisements, which are targeted according to known characteristics of the clients of an IP video multicast. Alternatively, the principles of the present invention may be applied to insertion of substantially any type of secondary content into various types of digital media broadcast streams.

There is therefore provided, in accordance with an embodiment of the present invention, a media receiver, including:

a network interface, which is configured to receive a primary digital broadcast media stream from a first server;

a media interface, which is coupled to play the media stream on an output device; and

a media processor, which is coupled between the network interface and the output interface so as to receive, via the network interface, an indication of an interval, having a start time and an end time, in the primary digital broadcast media stream in which secondary content is to be played on the output device, and a message identifying a second server that is to provide the secondary content,

wherein the media processor is configured, responsively to the indication and to the message, to suspend reception of the primary digital broadcast media stream at the start time while connecting to receive the secondary content from the second server so as to play the secondary content on the output device during the interval, and to resume reception of the primary digital broadcast media stream from the first server at the end time so as to resume playing the media stream on the output device.

In a disclosed embodiment, the network interface is configured to receive the primary digital broadcast media stream from the first server as a multicast stream over a packet network, and the media stream and the secondary content include video content, while the output device includes a video display.

In some embodiments, the indication includes a cue preceding the interval in the primary digital broadcast media stream, and the media processor is configured to detect the cue and to communicate with the second server responsively to the cue. Typically, the media processor is configured, responsively to the cue, to communicate via the network with a control subsystem prior to the start time in order to obtain instructions regarding the secondary content, and to communicate with the second server responsively to the instructions. The instructions may include a uniform resource identifier (URI) identifying the secondary content on the second server. Additionally or alternatively, the media processor may be configured to verify authenticity of the instructions received from the control subsystem.

In some embodiments, the media processor is configured to receive the secondary content by unicast from the second server. The media processor may be configured to open a video-on-demand (VOD) session with the second server, and to instruct the second server to begin transmission of the secondary content in the VOD session beginning at the start time.

Alternatively, the media processor is configured to join a multicast transmission by the second server in order to receive the secondary content.

There is also provided, in accordance with an embodiment of the present invention, apparatus for digital media distribution, including:

a plurality of client devices coupled to a network, each client device being configured to receive a primary digital broadcast media stream from a first server and to play the media stream on an output device and to receive, via the network, an indication of an interval, having a start time and an end time, in the primary digital broadcast media stream in which secondary content is to be played on the output device; and

a control subsystem, which is coupled to transmit to the client devices, via the network, a message identifying at least one second server that is to provide the secondary content,

wherein the message causes the client devices to suspend reception of the primary digital broadcast media stream at the start time while connecting to receive the secondary content from the at least one second server so as to play the secondary content on the output device during the interval, and to resume reception of the primary digital broadcast media stream from the first server at the end time so as to resume playing the media stream on the output device.

In some embodiments, the control subsystem is configured to transmit respective first and second messages to first and second client devices that are receiving the same primary digital broadcast media stream from the first server so as to cause the first and second client devices to receive the secondary content from different second servers.

Additionally or alternatively, the control subsystem is configured to transmit respective first and second messages to first and second client devices that are receiving the same primary digital broadcast media stream from the first server so as to cause the first and second client devices to receive and play different, first and second secondary content. In one embodiment, the control subsystem is coupled to receive information regarding characteristics of respective users of the first and second client devices, and to select the first and second secondary content responsively to the characteristics. Typically, the characteristics are selected from a group of characteristics consisting of personal characteristics of respective users of the client devices, preferences expressed by the respective users, behavior of the respective users, and respective geographical locations of the client devices.

In one embodiment, the message transmitted by the control subsystem to the client devices indicates the start time of the interval.

There is additionally provided, in accordance with an embodiment of the present invention, a method for distributing digital media, including:

receiving at a client device a primary digital broadcast media stream from a first server;

playing the media stream on an output device associated with the client device;

receiving at the client device an indication of an interval, having a start time and an end time, in the primary digital broadcast media stream in which secondary content is to be played on the output device and a message identifying a second server that is to provide the secondary content;

responsively to the indication and to the message, suspending reception at the client device of the primary digital broadcast media stream at the start time while connecting to receive the secondary content from the second server so as to play the secondary content on the output device during the interval; and

resuming reception of the primary digital broadcast media stream at the client device from the first server at the end time so as to resume playing the media stream on the output device.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for video multicasting, in accordance with an embodiment of the present invention;

FIG. 2 is a timing diagram showing video streams delivered to different clients in a video multicast system, in accordance with an embodiment of the present invention;

FIG. 3 is a block diagram that schematically shows functional elements in a video multicast system, in accordance with an embodiment of the present invention;

FIG. 4 is a block diagram that schematically shows details of a client device, in accordance with an embodiment of the present invention; and

FIG. 5 is a flow chart that schematically illustrates a method for inserting an advertisement into a video multicast stream, in accordance with an embodiment of the present invention.

### DETAILED DESCRIPTION OF EMBODIMENTS

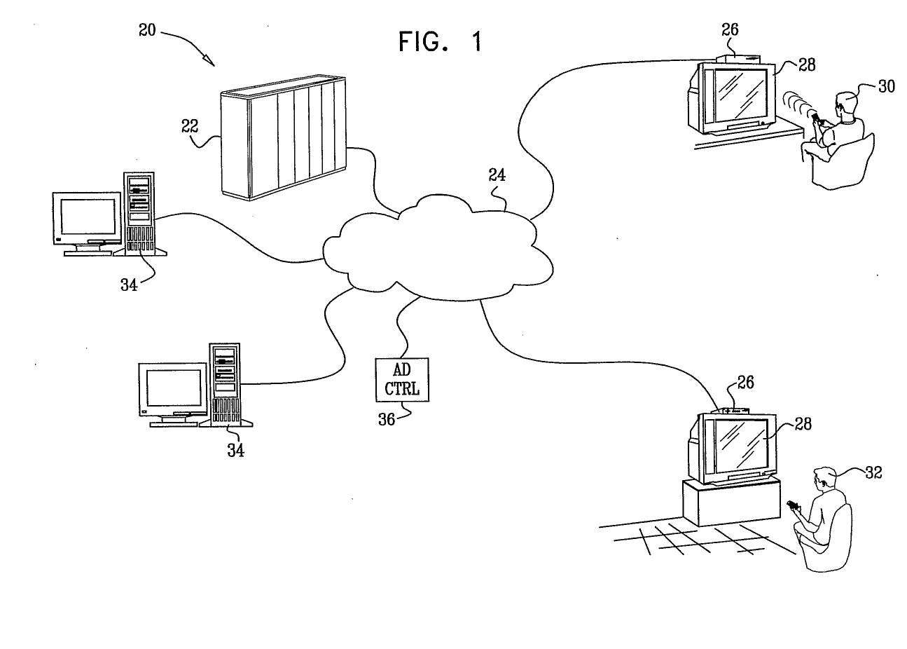

FIG. 1 is a block diagram that schematically illustrates a system 20 for video multicasting, in accordance with an embodiment of the present invention. A multicast server 22 distributes one or more digital broadcast media streams, in the form of multicast streams of packetized video content, over a packet network 24 to multiple clients 26. Although for the sake of simplicity, only a single multicast server is shown in the figure, the methods described hereinbelow may similarly be applied in systems in which clients 26 may access multiple different servers. Network 24 may comprise the public Internet or, additionally or alternatively, one or more private IP networks. Furthermore, although the embodiments described hereinbelow relate mainly to IP multicasting, the principles of the present invention may similarly be applied in connection with any suitable type of broadcast server.

Clients 26 comprise computerized devices with suitable hardware and software capabilities for carrying out the functions that are described hereinbelow. In the embodiment pictured in FIG. 1, clients 26 are assumed to be configured as television set-top boxes (STBs), which decode and present video programs on an output device, such as a video monitor 28, under control of users 30 and 32. Alternatively, the functions of clients 26 may be implemented in devices of other types, such as personal computers, “smart” television sets, or mobile receivers, which may be connected to network 24 via either wired or wireless connections.

The multicast streams transmitted by server 22 contain certain time slots that are allocated for insertion of advertisements or other secondary content, which is not part of the multicast stream itself. This secondary content is supplied by ad servers 34, which typically comprise unicast video-on-demand (VOD) or multicast servers. (For the sake of clarity, the description hereinbelow of methods and devices in system 20 refers specifically to insertion of advertisements, but the principles of these methods and devices may similarly be applied to insertion of substantially any sort of secondary content into a primary multicast stream.) Although servers 22 and 34 are all shown in FIG. 1 as connecting to clients 26 via the same network 24, the broadcast and ad servers may alternatively communicate with the clients via different networks. For example, the clients may receive the primary broadcast content via a satellite network and receive the secondary (advertising) content via a terrestrial network.

Typically, different clients 26 receiving the same multicast from server 22 may receive different, respective advertisements from the same or different ad servers 34. An ad control subsystem 36 determines which advertising content should be delivered to each client, depending on a predefined set of decision criteria. These criteria typically relate to known characteristics of the respective users of each client, as described further hereinbelow.

FIG. 2 is a timing diagram that schematically illustrates video streams that are delivered to different clients in system 20, in accordance with an embodiment of the present invention. Clients 26 in this example are identified as “STB A” and “STB B.” Multicast server 22 transmits a source multicast stream, shown in the top line of the figure. The source stream comprises primary content 40, such as a video entertainment broadcast, which is delivered to both clients, as shown in the second and third lines of the figure. The source stream also includes a default advertisement 42 in a certain predefined time interval, which is referred to hereinbelow as an ad interval.

At certain time T (typically a few seconds) before the beginning of the ad interval, server 22 transmits a marker, referred to as a cue, in the multicast stream. Cues that may be used for this purpose are defined, for example, by American National Standard ANSI/SCTE 35 2004, entitled “Digital Program Insertion Cueing Message for Cable” (Society of Cable Telecommunications Engineers, Exton, Pa.), which is incorporated herein by reference. The cue serves as an indication of the start time, and possibly the end time, of the approaching ad interval. Upon detecting this cue, the clients communicate with ad control subsystem 36, which tells each client which advertising content to insert in the ad interval and from which ad server 34 the content should be requested. This process is described in detail with reference to the figures that follow. Alternatively, clients may receive indications of ad intervals from ad control subsystem 36 or from other sources.

As a result of the interaction with the ad control subsystem and the appropriate ad server, STB A receives and inserts an advertisement 44 in the ad interval following the cue, while STB B receives and inserts two shorter advertisements 46 and 48. These advertisements may be individualized based on preference data that users 30 and 32 of the client devices have provided to subsystem 36 at an earlier time, as well as user characteristics. These characteristics may include, for example, gender, age, marital status, profession, income, leisure interests, and other factors that advertisers may use in defining their target audiences. Additionally or alternatively, subsystem 36 may use information regarding user behavior from other sources, such as purchasing, Web browsing, or television viewing habits of the users. Any suitable method of promotional targeting that is known in the art may be used by subsystem 36 in determining which advertisements to provide to each client.

Upon conclusion of the ad interval, the clients rejoin the multicast source stream and continue viewing primary content 40.

Clients that do not receive individualized content during the ad interval receive and display default advertisement 42 until the primary content resumes. For example, some client devices in system 20 may be conventional set-top boxes, which do not have the capability of decoding the cue and requesting individualized content and therefore receive the generic default advertisement. As another example, if network congestion or other operating conditions prevent certain client devices from completing the necessary interaction with the ad control subsystem and ad server during the time between the cue and the beginning of the ad interval, these client devices may likewise view the generic original advertisement.

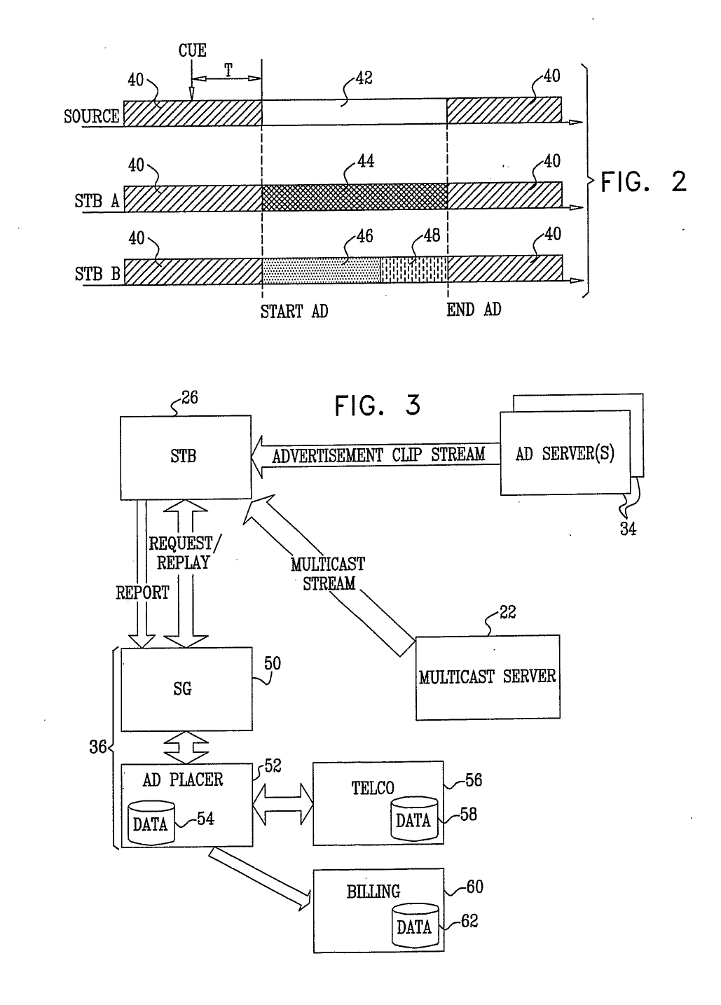

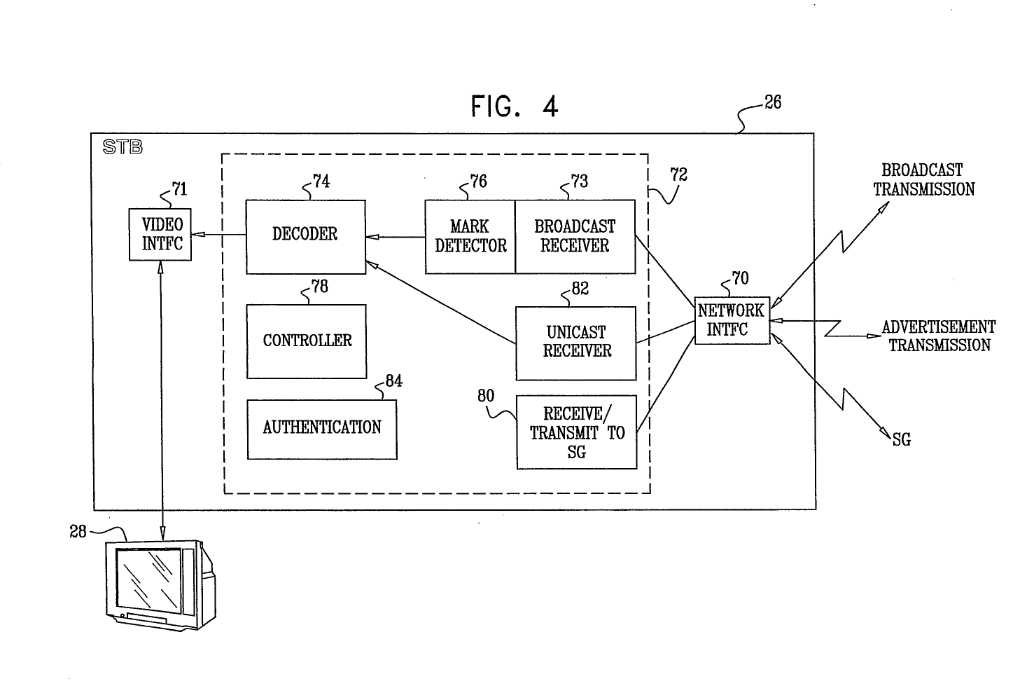

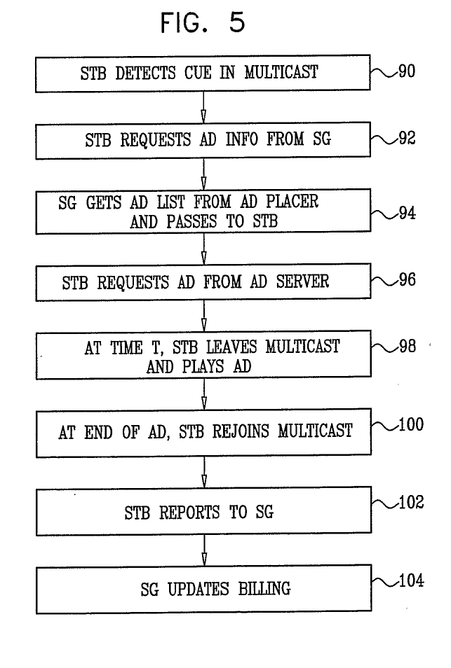

FIG. 3 is a block diagram that schematically shows functional elements of system 20 that participate in providing a video multicast with individualized advertising to client 26, in accordance with an embodiment of the present invention. Operation of these elements is described in greater detail below with reference to FIGS. 4 and 5.

As shown in FIG. 3, ad control subsystem 36 comprises a streaming gateway (SG) 50 and an ad placer 52. SG 50 in this embodiment comprises a suitable server, such as a Web server, for receiving requests and reports from clients 26 and giving the clients instructions regarding communication with ad servers 34. These instructions are generated for each client by an ad placer 52, based on ad data held in a memory 54, as well as individual client information held in a client database 58. The client database may be held by the ad placer itself. Alternatively or additionally, client database information may be provided by a third party server 56, which may be maintained, for example, by a telecommunications company or other network service provider. Ad placer 52 also generates records of client viewing of the advertisements provided by ad servers 34, and passes these records on for storage in a billing database 62 that is maintained by a billing server 60.

SG 50 and ad placer 52 typically comprise general-purpose computers, which are programmed in software to carry out the methods that are described herein. The software may be downloaded to subsystem 36 in electronic form, over a network, for example, or it may alternatively be provided on tangible media, such as optical, magnetic or electronic memory. Although the SG and ad placer are shown, for the sake of conceptual clarity, as separate functional blocks, these functions may be implemented together on the same computer or, alternatively, distributed among a group of several different computers. By the same token, servers 56 and 60 may be implemented within the same computer or group of computers, or they may comprise separate computers, which communicate with ad placer 52 over suitable communication links.

FIG. 4 is a block diagram that schematically shows details of client 26, in accordance with an embodiment of the present invention. Client 26 typically comprises a media processor 72, which is connected to a network interface 70, for communicating with network 24, and to a media interface, such as a video interface 71 for communicating with video monitor 28. The network and video interfaces are standard components, which will be apparent to those skilled in the art depending upon the types of network and video monitor with which client 26 is expected to communicate. When the primary and secondary content are transmitted over different networks (such as satellite and terrestrial networks, as mentioned above), network interface 70 may comprise an appropriate dual interface.

Processor 72 may comprise a suitable microprocessor (with memory and other peripheral components as required), which is programmed in software to carry out the functions that are described herein. The software may be downloaded to processor 72 in electronic form, or it may alternatively be provided on tangible media. Additionally or alternatively, some or all of the components of processor 72 may be implemented using custom, semi-custom or programmable hardware logic circuits. Although processor 72 is shown in FIG. 4, for clarity of explanation, as comprising certain functional blocks, these blocks do not necessarily correspond to particular hardware components. Rather, the functions of some or all of these blocks may be carried out by a single integrated circuit component. Alternatively, the functions of a given block may be distributed among a number of different components.

Processor 72 comprises a controller 78, which receives channel selection instructions from the user of client 26 and instructs a broadcast receiver 73 to select the desired video program stream. Receiver 73 receives the appropriate multicast packets via network interface 70 and passes the encoded video data in the packet payloads to a decoder 74. For example, the payloads may comprise MPEG-encoded compressed video, which decoder 74 decompresses and outputs via video interface 71 for display on monitor 28.

A mark detector 76 detects cues in the multicast packet sequence that are indicative of an approaching ad interval, as described above. Upon detecting a cue, detector 76 informs controller 78, which instructs an ad protocol unit 80 to query SG 50 regarding the content that should be displayed on monitor 28 during the coming ad interval. The ad protocol unit communicates with the SG by sending and receiving packets via network interface 70.

Upon receiving a response from the SG, ad protocol unit 80 instructs a unicast receiver 82 (either directly or via controller 78) to request the appropriate ad content from an ad server that is designated in the SG response. Optionally, an authentication unit 84 may be used to verify that the SG response is authentic, using a digital signature, for example, in order to prevent hackers from inserting unauthorized content into the ad intervals. Unicast receiver 82 receives packets from ad server 34 containing the requested ad content. At the beginning of the ad interval, controller 78 instructs broadcast receiver 73 to leave the current multicast and instructs unicast receiver 82 to pass the encoded video data in the ad packet payloads to decoder 74. During the ad interval, the decoder decompresses and outputs the ad content via video interface 71 to display 28. At the conclusion of the ad interval, controller 78 instructs broadcast receiver 73 to rejoin the multicast stream.

The above description of media processor assumes that ad servers 34 transmit ad content in unicast form. Alternatively or additionally, the ad servers may be configured for multicast transmission, in which case controller 78 instructs broadcast receiver 73 to join the appropriate ad multicast at the beginning of the ad interval and to leave it at the end to rejoin the primary multicast. In this scenario, unicast receiver 82 may be unnecessary.

FIG. 5 is a flow chart that schematically illustrates a method for inserting advertisements into a video multicast stream, in accordance with an embodiment of the present invention. The method is described, for the sake of clarity, with reference to the elements of system 20 and client 26 that are shown in the preceding figures, but it may similarly be implemented using other suitable network elements in other configurations.

After joining a multicast transmission selected by the user, client 26 (STB) detects a cue in the multicast, indicating that an ad interval is imminent, at a cue detection step 90. Typically, the cue contains metadata regarding the ad interval, including the time T remaining until the start of the interval and the duration of the interval, and possibly other types of data regarding the selection and presentation of the ad. In response to the cue, client 26 sends a request for ad information to SG 50, at an ad information request step 92. The request identifies the client (or the user operating the client), and may also indicate the duration of the coming ad interval and possibly other information, such as identifying the multicast channel to which the client is tuned.

SG 50 passes the information request to ad placer 52, at a request processing step 94. The ad placer retrieves information regarding the client from database 58. This information may include, for example, the client preferences and characteristics mentioned above, as well as other subscriber information, such as the geographical location, number of set-top boxes at the customer premises, and media viewing packages subscribed to by the customer. Ad placer 52 applies predetermined business logic rules to choose an ad or sequence of ads from a list in memory 54, which the client should be instructed to display during the ad interval. For each ad, the ad placer also determines an ad server or set of ad servers 34 from which the ad can be retrieved. SG 50 receives the list of one or more ads and corresponding ad servers from ad placer 52, and conveys the list in a message to client 26. The list may comprise, for example, the uniform resource identifiers (URIs) that may be used by the client to access the unicast or multicast ad content, as appropriate.

Ad content supplied by ad servers 34 may be further individualized based on other client details. For example, an ad for a chain of stores or restaurants might be followed by a short clip identifying the location of a franchise near the location of the client, or perhaps notifying users in proximity to a certain franchise location of a sale or special event at that location. In this case, SG 50 could send client 26 a list of two URIs at step 94, wherein the first URI accesses the ad, and the second URI accesses the short clip with local information. The combination of user characteristics with client location information permits advertisements to be precisely targeted at the appropriate audience.

It is possible that a hacker might attempt to intercept and modify communications between client 26 and SG 50 in order to change the ad content that the client displays during ad intervals. In this manner, the hacker could steal air time from a legitimate advertiser, who pays the operator of system 20 for advertising time, in order to display advertisements for a rogue advertiser. For example, the hacker might change the URI of the ad content in the message sent by the SG to the client at step 94 so that the URI points to an ad for the rogue advertiser rather than for the legitimate advertiser. In order to prevent this sort of hacking, SG 50 may digitally sign the messages that it sends at step 94, using a public key infrastructure, for example. Authentication unit 84 in client 26 may check the signature for validity before proceeding with the next step of the method.

Client 26 selects one of the ad servers from the list, and requests the appropriate ad content from the ad server, at an ad request step 96. The client may select the ad server, for example, based on geographical proximity and/or available capacity. The client asks the ad server to open a unicast VOD session or to join the ad multicast stream (depending upon whether the ad server and client are configured for unicast or multicast ad serving). For this purpose, the client may, for example, use the Real-Time Streaming Protocol (RTSP) to communicate with the ad server, as defined in Request for Comments (RFC) 2326 of the Internet Engineering Task Force (IETF) (April, 1998), which is incorporated herein by reference. A given ad server may supply the same ad content simultaneously to multiple clients, regardless of whether the clients are tuned to receive primary content on the same multicast channel or different multicast channels.

In an alternative embodiment, clients 26 may notify SG 50 whenever they change channels, so that the SG has a record of the channel that each client is receiving at any given time. The SG monitors the multicast streams in order to determine when ad intervals are about to occur. (In other words, the SG, rather than the clients, detects and processes the cues that precede ad intervals in the multicast streams.) Based on this information, the SG instructs ad servers 34 to multicast certain ad content on certain channels during the ad intervals, and directs each client to join the appropriate multicast channel in order to receive individualized ad content during these intervals. In other words, the SG indicates to each client both the start time of the ad interval and the server that is to provide the ad content. This approach may reduce the complexity of processing and communication that clients 26 must support, at the possible cost of reducing the level of individualization of ad content that may be achieved by system 20.

After connecting (by unicast or multicast) to the ad server, client 26 begins playing the selected ad content at the beginning of the ad interval, i.e., at time T following the cue, at an ad playing step 98. For this purpose, in unicast VOD mode for example, the client sends a RTSP PLAY command to ad server 34 and stops receiving the primary multicast stream from server 22 by sending a LEAVE command to network 24. Client 26 thus receives and displays the ad provided by server 34 on video monitor 28. As noted above, if the client does not receive an individualized ad (due to failure to detect the cue at step 90, failure to receive the ad list from SG 50 at step 94, or failure to receive the ad content at step 98, for example), the client simply plays default ad 42, which is embedded in the multicast stream transmitted by server 22.

During the ad interval, the user may attempt to change multicast channels in order to avoid watching the advertisement. Optionally, client 26 may be configured to block channel changes during ad intervals, or to allow such channel changes only for premium subscribers. Alternatively or additionally, different multicast streams transmitted by server 22 may have synchronized ad intervals, so that the user will continue to receive and view the advertisement regardless of possible channel switching. Further additionally or alternatively, client 26 may keep a record of channel switching behavior during ad intervals for purposes of reporting, as described hereinbelow.

At the end of the advertisement, ad server 34 sends an end-of-stream notification to client 26, at an ad conclusion step 100. At this point, the client rejoins the multicast channel that it was receiving before the ad interval, and resumes displaying the primary multicast content on the video monitor. Alternatively, the “mark-in” cue in the multicast stream that the client received at step 90, indicating the beginning of the ad interval, may be followed by a “mark-out” cue indicating the end of the ad interval. Client 26 may rejoin the multicast at the time indicated by the mark-out cue, in addition to or instead of relying on the end-of-stream notification provided by the ad server.

Following the ad interval, client 26 may send a usage report to SG 50, at a reporting step 102. Typically, the usage report will indicate that the ad content was played successfully. The SG passes the usage information to ad placer 52, which reports ad usage to billing server 60, at a billing step 104. The billing server charges advertisers according to the number of times their respective advertisements were displayed by clients 26. Alternatively, if a user switched away during the ad interval and did not view the entire advertisement, the usage report from client 26 will indicate that the user saw only a certain portion of the advertisement. In such a case, billing server 60 may charge the advertiser at a reduced rate or may not charge the advertiser at all.

Although the embodiments described above relate mainly to insertion of advertising content into commercial video broadcasts, the principles of the present invention may similarly be applied in inserting substantially any sort of individualized secondary content into a digital broadcast stream of primary media content. The media may comprise video media, as described above, or substantially any other type of digital media that may be transmitted over a network, such as animations or audio.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A media receiver, comprising:
a network interface, which is configured to receive a primary digital broadcast media stream from a first server;
a media interface, which is coupled to play the media stream on an output device; and
a media processor, which is coupled between the network interface and the output interface so as to receive, via the network interface:
an indication of an interval, having a start time and an end time, in the primary digital broadcast media stream in which secondary content is to be played on the output device; and
a message identifying a second server that is to provide the secondary content,
wherein the media processor is configured, responsively to the indication and to the message, to suspend reception of the primary digital broadcast media stream at the start time while connecting to receive the secondary content from the second server so as to play the secondary content on the output device during the interval, and to resume reception of the primary digital broadcast media stream from the first server at the end time so as to resume playing the media stream on the output device.

2. The receiver according to claim 1, wherein the network interface is configured to receive the primary digital broadcast media stream from the first server as a multicast stream over a packet network.

3. The receiver according to claim 1, wherein the media stream and the secondary content comprise video content, and wherein the output device comprises a video display.

4. The receiver according to claim 1, wherein the indication comprises a cue preceding the interval in the primary digital broadcast media stream, and wherein the media processor is configured to detect the cue and to communicate with the second server responsively to the cue.

5. The receiver according to claim 4, wherein the media processor is configured, responsively to the cue, to communicate via the network with a control subsystem prior to the start time in order to obtain instructions regarding the secondary content, and to communicate with the second server responsively to the instructions.

6. The receiver according to claim 5, wherein the instructions comprise a uniform resource identifier (URI) identifying the secondary content on the second server.

7. The receiver according to claim 5, wherein the media processor is configured to verify authenticity of the instructions received from the control subsystem.

8. The receiver according to claim 1, wherein the media processor is configured to receive the secondary content by unicast from the second server.

9. The receiver according to claim 8, wherein the media processor is configured to open a video-on-demand (VOD) session with the second server, and to instruct the second server to begin transmission of the secondary content in the VOD session beginning at the start time.

10. The receiver according to claim 1, wherein the media processor is configured to join a multicast transmission by the second server in order to receive the secondary content.

11. Apparatus for digital media distribution, comprising:
a plurality of client devices coupled to a network, each client device being configured to receive a primary digital broadcast media stream from a first server and to play the media stream on an output device and to receive, via the network, an indication of an interval, having a start time and an end time, in the primary digital broadcast media stream in which secondary content is to be played on the output device; and
a control subsystem, which is coupled to transmit to the client devices, via the network, a message identifying at least one second server that is to provide the secondary content,
wherein the message causes the client devices to suspend reception of the primary digital broadcast media stream at the start time while connecting to receive the secondary content from the at least one second server so as to play the secondary content on the output device during the interval, and to resume reception of the primary digital broadcast media stream from the first server at the end time so as to resume playing the media stream on the output device.

12. The apparatus according to claim 11, wherein the control subsystem is configured to transmit respective first and second messages to first and second client devices that are receiving the same primary digital broadcast media stream from the first server so as to cause the first and second client devices to receive the secondary content from different second servers.

13. The apparatus according to claim 11, wherein the control subsystem is configured to transmit respective first and second messages to first and second client devices that are receiving the same primary digital broadcast media stream from the first server so as to cause the first and second client devices to receive and play different, first and second secondary content.

14. The apparatus according to claim 13, wherein the control subsystem is coupled to receive information regarding characteristics of respective users of the first and second client devices, and to select the first and second secondary content responsively to the characteristics.

15. The apparatus according to claim 14, wherein the characteristics are selected from a group of characteristics consisting of personal characteristics of respective users of the client devices, preferences expressed by the respective users, behavior of the respective users, and respective geographical locations of the client devices.

16. The apparatus according to claim 11, wherein the client devices are configured to receive the primary digital broadcast media stream from the first server as a multicast stream over a packet network.

17. The apparatus according to claim 11, wherein the media stream and the secondary content comprise video content.

18. The apparatus according to claim 11, wherein the indication comprises a cue preceding the interval in the primary digital broadcast media stream, and wherein the client devices are configured to detect the cue and to communicate with the control subsystem responsively to the cue so as to receive the message identifying the at least one second server.

19. The apparatus according to claim 18, wherein the message comprises a uniform resource identifier (URI) identifying the secondary content on the second server.

20. The apparatus according to claim 18, wherein the control subsystem is configured to generate the message so as to enable the client devices to verify authenticity of the message.

21. The apparatus according to claim 11, wherein the message transmitted by the control subsystem to the client devices indicates the start time of the interval.

22. The apparatus according to claim 11, wherein the client devices are configured to receive the secondary content by unicast from the second server.

23. The apparatus according to claim 11, wherein the client devices are configured to join a multicast transmission by the second server in order to receive the secondary content.

24. A method for distributing digital media, comprising:
receiving at a client device a primary digital broadcast media stream from a first server;
playing the media stream on an output device associated with the client device;
receiving at the client device an indication of an interval, having a start time and an end time, in the primary digital broadcast media stream in which secondary content is to be played on the output device and a message identifying a second server that is to provide the secondary content;
responsively to the indication and to the message, suspending reception at the client device of the primary digital broadcast media stream at the start time while connecting to receive the secondary content from the second server so as to play the secondary content on the output device during the interval; and
resuming reception of the primary digital broadcast media stream at the client device from the first server at the end time so as to resume playing the media stream on the output device.

25. The method according to claim 24, wherein receiving the primary digital broadcast media stream comprises receiving a multicast stream over a packet network.

26. The method according to claim 24, wherein the media stream and the secondary content comprise video content, and wherein the output device comprises a video display.

27. The method according to claim 24, wherein the indication comprises a cue preceding the interval in the primary digital broadcast media stream, and wherein connecting to receive the secondary content comprises detecting the cue at the client device and communicating with the second server responsively to the cue.

28. The method according to claim 24, wherein receiving the message comprises communicating via the network between the client device and a control subsystem prior to the start time in order to provide instructions from the control subsystem to the client device regarding the secondary content, and wherein connecting to receive the secondary content comprises communicating with the second server responsively to the instructions.

29. The method according to claim 28, wherein the instructions comprise a uniform resource identifier (URI) identifying the secondary content on the second server.

30. The method according to claim 28, wherein communicating between the client device and the control subsystem comprises verifying authenticity at the client devices of the instructions received from the control subsystem.

31. The method according to claim 28, wherein communicating via the network between the client device and the control subsystem comprises transmitting the indication of the interval from the control subsystem to the client device.

32. The method according to claim 28, wherein the communicating via the network between the client device and the control subsystem comprises transmitting respective first and second messages to first and second client devices that are receiving the same primary digital broadcast media stream from the first server so as to cause the first and second client devices to receive the secondary content from different second servers.

33. The method according to claim 28, wherein the communicating via the network between the client device and the control subsystem comprises transmitting respective first and second messages from the control subsystem to first and second client devices that are receiving the same primary digital broadcast media stream from the first server so as to cause the first and second client devices to receive and play different, first and second secondary content.

34. The method according to claim 33, transmitting the respective first and second messages comprises receiving at the control subsystem information regarding characteristics of respective users of the first and second client devices, and selecting the first and second secondary content responsively to the characteristics.

35. The method according to claim 34, wherein the characteristics are selected from a group of characteristics consisting of personal characteristics of respective users of the client devices, preferences expressed by the respective users, behavior of the respective users, and respective geographical locations of the client devices.

36. The method according to claim 24, wherein connecting to receive the secondary content comprises receiving the secondary content by unicast from the second server.

37. The method according to claim 36, wherein receiving the secondary content comprises opening a video-on-demand (VOD) session between the client device and the second server, and instructing the second server to begin transmission of the secondary content in the VOD session beginning at the start time.

38. The method according to claim 24, wherein receiving the secondary content comprises joining a multicast transmission by the second server in order to receive the secondary content.
